(19) United States
(12) Patent Application Publication
(10) Pub. No.: US 2002/0124201 A1
(43) Pub. Date: Sep. 5, 2002

(54) Method and system for log repair action handling on a logically partitioned multiprocessing system

(75) Inventors: Mark Steven Edwards, Austin, TX (US); George Henry Ahrens JR., Pflugerville, TX (US); Douglas Marvin Benignus, Dime Box, TX (US); Arthur James Tysor, Buda, TX (US)

Correspondence Address: SAWYER LAW GROUP, P.O. Box 51418, Palo Alto, CA, 94303, US

(73) Assignee: International Business Machines Corporation, Armonk, NY (US)

(21) Appl. No.: 09/798,290

(22) Filed: Mar. 1, 2001

(51) Int. Cl. G06F 11/00

(52) U.S. Cl. 714/5

(57) ABSTRACT

A method for handling a log repair action in a logically partitioned (LPAR) multiprocessing system is disclosed. The LPAR multiprocessing system includes a plurality of partitions. The method and system comprise recording the log repair action on one of the plurality of partitions. The method and system further include sending the recording of the log repair action to a single log repair action source, the recording including the log repair action and the partition identifier of the one of the plurality of partitions. The method and system further includes sending the log repair action to each of the other of the plurality of partitions from the single service. Accordingly, a system and method in accordance with the present invention solves the problem of having to perform the same action in multiple partitions by using a notification scheme with a single focal point of control. When the focal point determines that the action performed is common to other partitions, that action is broadcast by the focal point to the other partitions and thus eliminates the need for visiting each partition to repeat the action. Each receiving partition uses the broadcast information to update its log repair action record. Accordingly shortened repair scenarios and less interruptions to actively working partitions is provided, thus providing the customer with increased system availability which should result in higher customer satisfaction.

### FIELD OF THE INVENTION

The present invention relates generally to logically partitioned multiprocessing systems and more particularly to log repair action handling in such systems.

### BACKGROUND OF THE INVENTION

Logical partitioning is the ability to make a single multiprocessing system run as if it were two or more independent systems. Each logical partition represents a division of resources in the system and operates as an independent logical system. Each partition is logical because the division of resources may be physical or virtual. An example of logical partitions is the partitioning of a multiprocessor computer system into multiple independent servers, each with its own processors, main storage, and I/O devices.

In a logically partitioned system, local errors (I/O adapters for that partition only) are reported on to the OS running on that partition. Global errors (errors that could affect all partitions, e.g., fan, power supply, memory, etc.) get reported to all operating systems. Currently when repairs are made, even Global repairs, the repair action is only recorded in the error log for the partition having the error. It would be advantageous to report the repair to all partitions, without the need to repetitively enter the repair data in each partition's log.

FIG. 1 is a block diagram of a logically partitioned LPAR multiprocessing system 100. The multiprocessing system 100 includes a plurality of operating system (OS) partitions 102a, 102b, 102c and 102d which receive inputs locally from a plurality of input/output devices (IOs) 104 and globally from base hardware 106, for example, a power supply, a cooling supply, a fan, memory, and processors. Although four OS partitions are shown herein one of ordinary skill in the art readily recognizes any number of partitions can be utilized within the spirit and scope of the present invention. Each of the OS partitions 102a-102d include an identification (id) number 105a-105d.

In such systems it is desirable to report a repair action on a global resource that is recorded in the error log on one partition to the error logs in all of the other partitions that share the resource. The partitions are isolated from one another so there is no knowledge of any other partition's error log information. If a hardware error is logged that requires a service action, diagnostics will continue to report the problem until a log repair action is logged. In a conventional LPAR multiprocessing system, each partition that shares the “repaired” resource must be visited (by either running diagnostics in system verification mode or using the log repair action service aid) to manually record the repair action or the global resource will continue to be reported as a problem in those partitions and not in the partition where the repair action was recorded. This adds significant time and customer disruption to manually record every repair action for globally reported errors.

Accordingly, what is needed is a system and method for reducing the amount of time required to record the repair action of global errors. The system and method should be cost effective, easily implemented and readily adaptable to existing systems. The present invention addresses such a need.

### SUMMARY OF THE INVENTION

A method for handling a log repair action in a logically partitioned (LPAR) multiprocessing system is disclosed. The LPAR multiprocessing system includes a plurality of partitions. The method and system comprise recording the log repair action on one of the plurality of partitions. The method and system further include sending the recording of the log repair action to a single log repair action source, the recording including the log repair action and the partition identifier of the one of the plurality of partitions. The method and system further includes sending the log repair action to each of the other of the plurality of partitions from the single service.

Accordingly, a system and method in accordance with the present invention solves the problem of having to perform the same action in multiple partitions by using a notification scheme with a single focal point of control. When the focal point determines that the action performed is common to other partitions, that action is broadcast by the focal point to the other partitions and thus eliminates the need for visiting each partition to repeat the action. Each receiving partition uses the broadcast information to update its log repair action record. Accordingly shortened repair scenarios and less interruptions to actively working partitions is provided, thus providing the customer with increased system availability which should result in higher customer satisfaction.

### BRIEF DESCRIPTION OF THE DRAWINGS

FIG. 1 is a block diagram of a logically partitioned multiprocessing system.

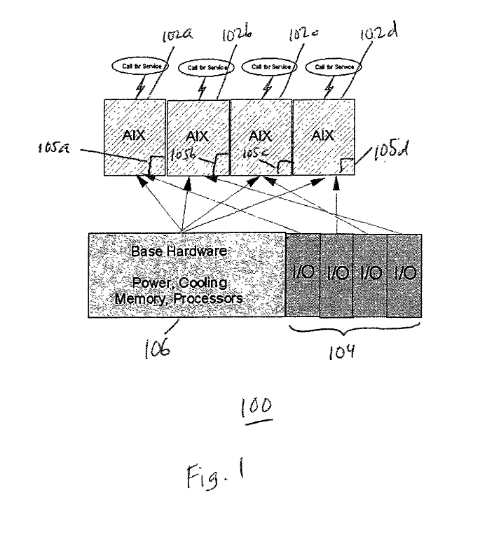

FIG. 2 is a diagram of a service focal point application in accordance with the present invention.

FIG. 2a is a block diagram of a single partition.

FIG. 3 is a flow chart which illustrates a process for minimizing duplicate reported errors in an LPAR multiprocessing system in accordance with the present invention.

FIG. 4 is a flow chart of the process for updating the error logs on the partitions.

### DETAILED DESCRIPTION OF THE INVENTION

The present invention relates generally to logically partitioned multiprocessing systems and more particularly to log repair action handling in such systems. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

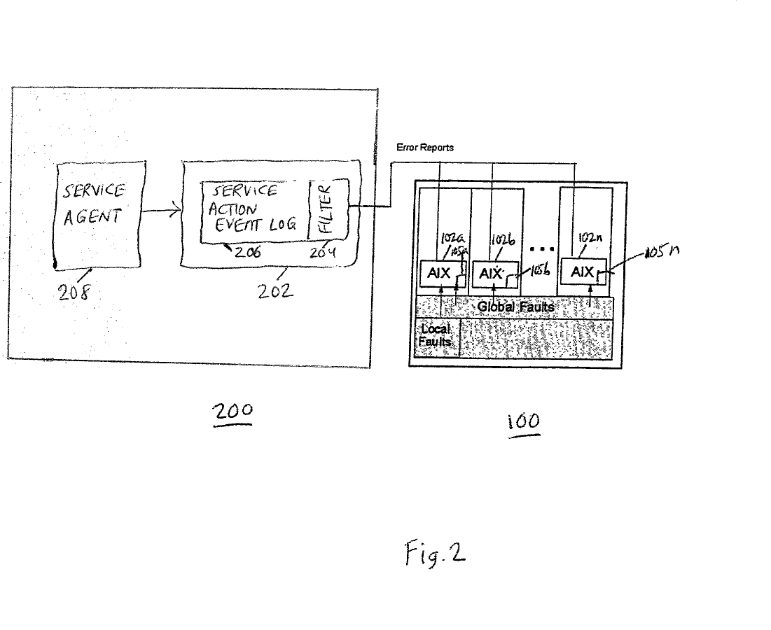

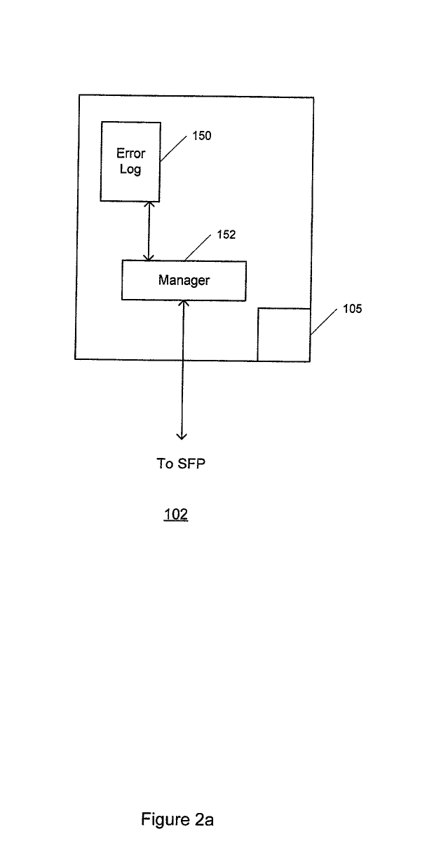

The present invention uses a procedure within a service focal point (SFP) application within a hardware system console to handle the log repair actions within each partition related to globally reported failures. FIG. 2 is a diagram of a service focal point (SFP) application in accordance with the present invention. In this system an SFP application 202 resides on a hardware system console 200. The hardware console 200 includes a processor (not shown) that runs the SFP application 202. The SFP application 202 typically resides on a computer readable medium such as a floppy, disk drive, CD ROM, DVD, or the like. The service focal point application 202 includes a service action event (SAE) log 204 which receives error reports from the OS partitions 102a-102n via a filter 206. Another application on the hardware system console is a service agent 208 which receives filtered information concerning the error reports and issues calls for service. As is seen, in the LPAR multiprocessing system there are global faults which are provided from each of the operating systems 102a-102n along with local faults that can be provided from each partition. Each of the OS partitions 102a-102n upon receiving a fault will send an error report to the service focal point application in the hardware system. Each OS partition 102a-102n includes an error log therewith.

FIG. 2a is a block diagram of a single partition 102. The partition 102 includes an error log 150 which is in communication with a manager 152. The manager 152 receives information from and transmits information to the SFP application 202 (FIG. 2). The manager performs log repair diagnostics. Co-pending U.S. patent application Ser. No. ______entitled “Method and System for Eliminating Duplicate Reported Errors in a Logically Partitioned Multiprocessing System” is directed to minimizing the number of errors reported to a service representative.

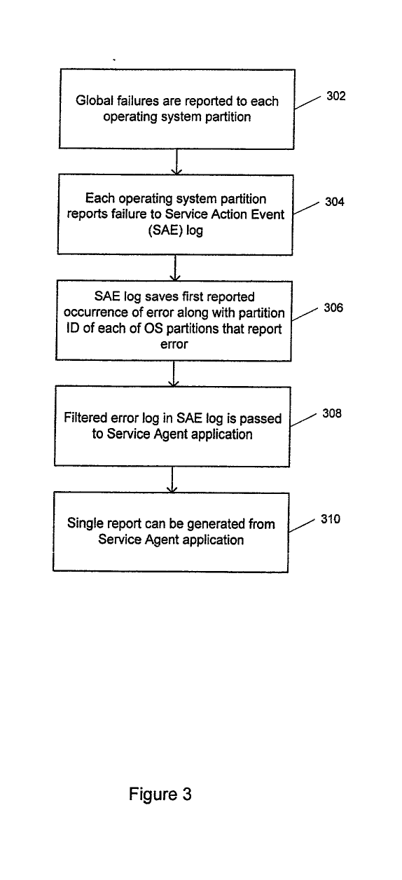

FIG. 3 is a flow chart which illustrates a process for minimizing duplicate reported errors in an LPAR multiprocessing system in accordance with the above-identified co-pending application. Referring now to FIGS. 2 and 3 together, globally reported failures are reported to each OS partition 102a-102n, via step 302. In turn, each operating system partition reports the failure to the SAE Log 204 in the Service Focal Point application, via step 304. The SAE log 204 includes a filtering mechanism to filter replicated error logs from the OS partitions 102a-102n. The SAE log 204 then saves the first reported occurrence of the error along with the partition IDs 105a-105n of each of the OS partitions 102a-102n that reported the error for later use by the service representative, via step 306. The filtered error log in the SAE Log 204 is then passed to the Service Agent application 208, via step 308. The Service Agent application then sends a single report to a service representative for a call for service, via step 310.

The above-identified co-pending application is directed towards ensuring that duplicate errors are not reported to the Service Agent from the SFP. The present invention is directed to the updating of the partitions after the service has been performed to ensure that the user of the particular partition does not continue to see the problem being reported by diagnostics.

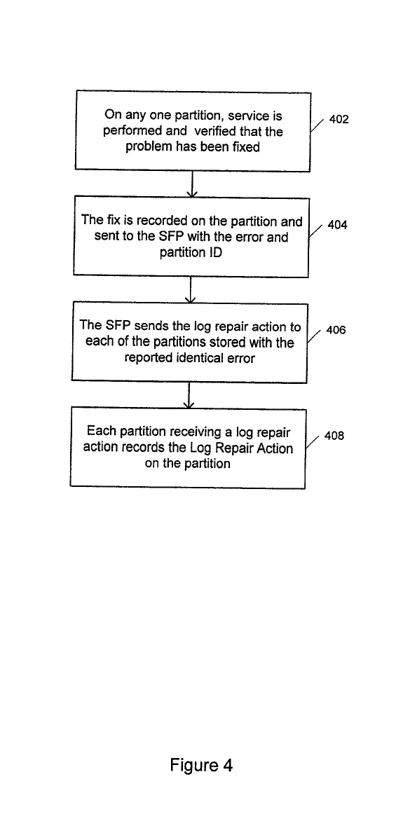

To more particularly describe the features of the present invention refer to the following discussion in conjunction with the associated figures. FIG. 4 is a flow chart of the process for updating the error logs on the partitions. Referring to FIGS. 2, 2a and 4 together, first after the service is performed, the fix is recorded on the repaired partition and sent to the SFP application 202 with an error and partition ID number of that partition, via step 404. Thereafter, the SFP application 202 will send a log repair action to each of the partitions which reported the identical error, via step 406. Thereafter, each partition that received the log repair action records the log repair action on its error log 150 via the program manager 152, via step 408. Accordingly, through the use of the SFP application 202 the log repair action can be performed automatically rather than the user having to perform that action manually.

Accordingly, in accordance with the present invention, when the service representative performs a successful repair action on the failing resource, it is recorded on the partition and passed to the focal point of control with the error code and the location code of the fixed resource as well as the reporting partition information. At this point only one of the partitions is aware that the resource has been fixed, and if not corrected could cause unnecessary repair actions on the unaware partitions. From the repair action notification, the focal point of control determines which, if any, of the other partitions received the same error. For each of the other partitions that reported the same error on the same resource, the focal point of control sends notification of the repair to the other partitions. Then the other partitions record the repair action just as if the service representative performed the action in that partition.

Accordingly, a system and method in accordance with the present invention solves the problem of having to perform the same action in multiple partitions by using a notification scheme with a single focal point of control. When the focal point determines that the action performed is common to other partitions, that action is broadcast by the focal point to the other partitions and thus eliminates the need for visiting each partition to repeat the action. Accordingly shortened repair scenarios and less interruptions to actively working partitions is provided, thus providing the customer with increased system availability which should result in higher customer satisfaction.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for handling a log repair action in a logically partitioned (LPAR) multiprocessing system, the LPAR multiprocessing system including a plurality of partitions and the log repair action being responsive to globally reported errors, the method comprising the steps of:
(a) recording the log repair action on one of the plurality of partitions;
(b) sending the recording of the log repair action to a single log repair action source, the recording including the log repair action and the partition identifier of the one of the plurality of partitions; and
(c) sending the log repair action to each of the other of the plurality of partitions from the single service.

2. The method of claim 1 which further comprises the step of:
(d) recording the log repair action by the other of the plurality of partitions.

3. The method of claim 2 wherein the log repair action is recorded in an error log within each of the other of the plurality of partitions.

4. A system for handling a log repair action in a logically partitioned (LPAR) multiprocessing system, the LPAR multiprocessing system including a plurality of partitions and the log repair action being responsive to globally reported errors, the system comprising:
a service action event (SAE) log for receiving, filtering a plurality of related globally reported errors for a plurality of partitions in the multiprocessing system, wherein the SAE log saves only the first occurrence of the plurality of globally reported errors and for providing a log repair action to each of the other of the plurality of partitions; and
an error log within each of the partitions for receiving the log repair action from the SAE log and for recording the log repair action therewith.

5. The system of claim 4 wherein the SAE log further comprises:
means for receiving the plurality of related globally reported errors from the LPAR multiprocessing system;
means for saving a first occurrence of the plurality of related globally reported errors; and
means for sending the first occurrence to a service agent.

6. The system of claim 5 wherein the SAE log further comprises:
means for saving an identification of each partition that has reported a failure.

7. A computer readable medium containing program instructions for handling a log repair action in a logically partitioned (LPAR) multiprocessing system, the LPAR multiprocessing system including a plurality of partitions and the log repair action being responsive to globally reported errors, the program instructions for:
(a) recording the log repair action on one of the plurality of partitions;
(b) sending the recording of the log repair action to a single log repair action source, the recording including the log repair action and the partition identifier of the one of the plurality of partitions; and
(c) sending the log repair action to each of the other of the plurality of partitions from the single service.

8. The computer readable medium of claim 7 which further comprises the step of:
(d) recording the log repair action by the other of the plurality of partitions.

9. The computer readable medium of claim 8 wherein the log repair action is recorded in an error log within each of the other of the plurality of partitions.
